(19) United States
(12) Patent Application Publication
(10) Pub. No.: US 2026/0278971 A1
(43) Pub. Date: Sep. 17, 2026

(54) INFORMATION PROCESSING APPARATUS, INFORMATION PROCESSING METHOD, and PROGRAM

(71) Applicant: Sony Group Corporation, Tokyo (JP)

(72) Inventors: Goro TAKAKI, Tokyo (JP); Kenichiro TOYOSHIMA, Tokyo (JP); Yoichi HIROTA, Kanagawa (JP)

(73) Assignee: Sony Group Corporation, Tokyo (JP)

(21) Appl. No.: 19/167,779

(22) PCT Filed: Feb. 5, 2024
(86) PCT No.: PCT/JP2024/003773

§ 371 Date: Sep. 22, 2025

(30) Foreign Application Priority Data
Mar. 29, 2023 (JP) 2023-052587

(51) Int. Cl. G06T 19/20

(52) U.S. Cl. CPC G06T 19/20; G06T 2219/2021; G06T 2219/2024

(57) ABSTRACT

There is provided an information processing apparatus to adjust an appearance of a three-dimensional object according to visual features of a metaverse. The information processing apparatus includes an acquisition section that acquires an analysis result of visual features of a virtual world, a style adjustment section that adjusts a user's 3D object data on the basis of the analysis result, and an output section that deploys the adjusted 3D object data in the virtual world so as to place a 3D object corresponding to the 3D object data in the virtual world.

### TECHNICAL FIELD

The present disclosure relates to an information processing apparatus, an information processing method, and a program.

### Background Art

In recent years, there has been increasing interest in a metaverse, a three-dimensional virtual world constructed in a computer. Various platformers have thus constructed metaverses with various worldviews.

Here, each metaverse has a unique color, atmosphere, or style based on its own worldview. Hence, in a case where a creator deploys an object created by the creator itself to a metaverse, for example, it is possible, depending on a worldview of the metaverse, that the deployed object does not fit the metaverse and causes discomfort.

For example, PTL 1 listed below discloses a technique for enhancing compatibility in appearance between a real space and a virtual object by, at the time of displaying the virtual object on the real space in a superimposed manner, correcting a color of the virtual object such that color tones of the real space and the virtual object match with each other.

### Citation List

### Patent Literature

PTL 1:
Japanese Patent Laid-open No. 2002-163670

### SUMMARY

### Technical Problem

However, since a metaverse is a three-dimensional space, it has been difficult to make an object fit the worldview of the metaverse by simply correcting the color tone of the object. Accordingly, there has been a demand for a technique for adjusting the appearance of a three-dimensional object to be placed in a metaverse, in such a manner as to fit the worldview of the metaverse more suitably.

### Solution to Problem

According to the present disclosure, there is provided an information processing apparatus including an acquisition section that acquires an analysis result of visual features of a virtual world, a style adjustment section that adjusts a user's 3D object data on the basis of the analysis result, and an output section that deploys the adjusted 3D object data to the virtual world so as to place a 3D object corresponding to the 3D object data in the virtual world.

Further, according to the present disclosure, there is provided an information processing method executed by a computer, including acquiring an analysis result of visual features of a virtual world, adjusting a user's 3D object data on the basis of the analysis result, and deploying the adjusted 3D object data to the virtual world so as to place a 3D object corresponding to the 3D object data in the virtual world.

Furthermore, according to the present disclosure, there is provided a program for causing a computer to function as an acquisition section that acquires an analysis result of visual features of a virtual world, a style adjustment section that adjusts a user's 3D object data on the basis of the analysis result, and an output section that deploys the adjusted 3D object data to the virtual world so as to place a 3D object corresponding to the 3D object data in the virtual world.

### BRIEF DESCRIPTION OF DRAWINGS

FIG. 1 is a schematic diagram describing a technical background of an information processing apparatus according to an embodiment of the present disclosure.

FIG. 2 is an explanatory diagram illustrating an exemplary metaverse.

FIG. 3 is an explanatory diagram illustrating another exemplary metaverse.

FIG. 4 is an explanatory diagram illustrating another exemplary metaverse.

FIG. 5 is an explanatory diagram illustrating another exemplary metaverse.

FIG. 6 is a block diagram describing a configuration of the information processing apparatus according to the same embodiment.

FIG. 7 is a flowchart illustrating a flow of a first operation example of the information processing apparatus according to the same embodiment.

FIG. 8 is a flowchart illustrating a flow of a second operation example of the information processing apparatus according to the same embodiment.

FIG. 9 is a block diagram illustrating a hardware configuration example of the information processing apparatus according to the same embodiment.

### DESCRIPTION OF EMBODIMENT

A preferred embodiment of the present disclosure will be described in detail below with reference to the accompanying drawings. It is to be noted in the present specification and drawings that constituent elements having substantially the same functional configuration are denoted by the same reference sign and that a redundant description is omitted.

It is to be noted that the description will be given in the following order.
1. Technical background
2. Configuration example
3. Operation examples
   3.1. First operation example
   3.2. Second operation example
4. Hardware configuration example

### 1. Technical Background

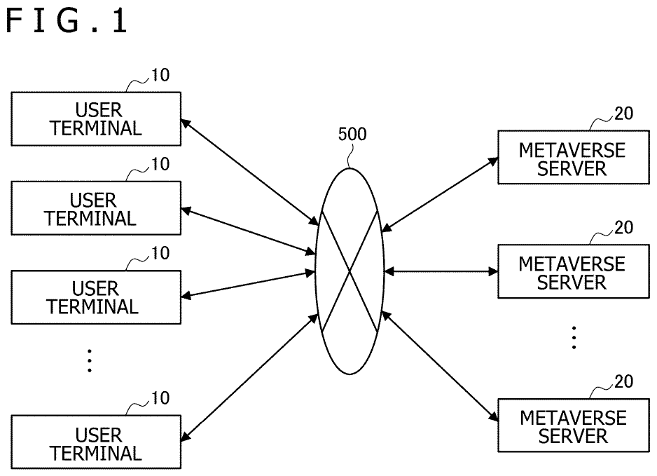

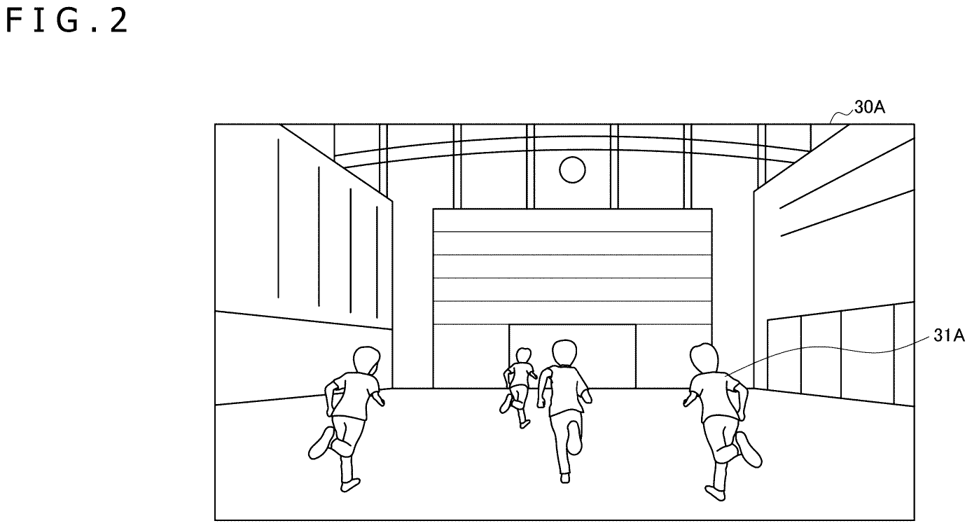

First, a technical background of an information processing apparatus according to an embodiment of the present disclosure will be described with reference to FIG. 1 through FIG. 5. FIG. 1 is a schematic diagram describing the technical background of the information processing apparatus according to the present embodiment. FIG. 2 through FIG. 5 are explanatory diagrams illustrating various exemplary metaverses.

As illustrated in FIG. 1, users can each access one or more metaverses (virtual worlds) constructed in respective metaverse servers 20, by use of respective user terminals 10.

Each metaverse server 20 is an information processing apparatus that stores therein metaverse information for use in constructing a metaverse. The metaverse server 20 transmits the metaverse information to the user terminal 10 through a network 500, thereby allowing the user terminal 10 to display scenery and the like of the metaverse. One metaverse server 20 is prepared for each of different metaverses. The metaverse servers 20 may be separate physical servers prepared individually for the respective metaverses or may be separate virtual servers provided in one physical server.

The metaverse information transmitted to the user terminal 10 includes, for example, map data regarding the metaverse, data regarding a virtual object to be placed in the metaverse (e.g., shape, texture, three-dimensional position, and posture), and the like. This enables the user terminal 10 to display the scenery in the metaverse as an image on the basis of the received metaverse information.

The user terminal 10 is an information processing terminal used by a user. The user terminal 10 may be, for example, a smartphone, a tablet terminal, a personal computer, an HMD (Head mounted Display) device, a glasses-type terminal, a projector, or the like. The user terminal 10 can present the scenery in the metaverse generated on the basis of the metaverse information to the user, by receiving the metaverse information from the metaverse server 20. As a result, by operating the user terminal 10, the user can make such actions as movement in the metaverse and conversation in the metaverse.

In recent years, there have been a wide variety of metaverses presented by various platformers. Therefore, it is a common practice that one user participates in multiple metaverses.

In such a case, it is possible that the user wants to use an avatar character operated by the user himself/herself, continuously in multiple metaverses. In addition, in a case where the user deploys content created by the user himself/herself to a metaverse, it is possible that the user wants to deploy the created content to multiple metaverses.

However, since metaverses have their own unique worldviews, in a case where the same avatar character or content is deployed to multiple metaverses, the appearance of the avatar character or the content may not possibly fit the worldviews of the metaverses.

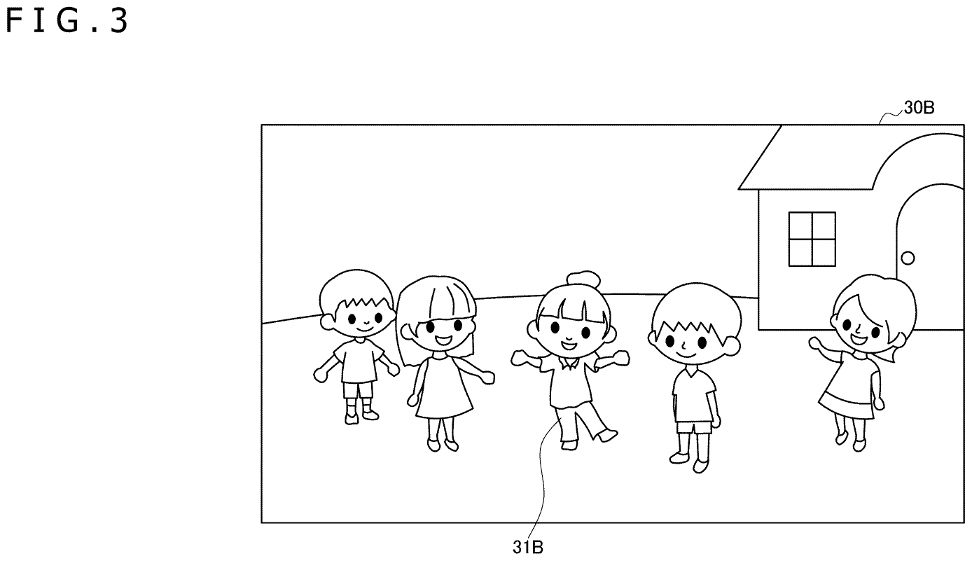

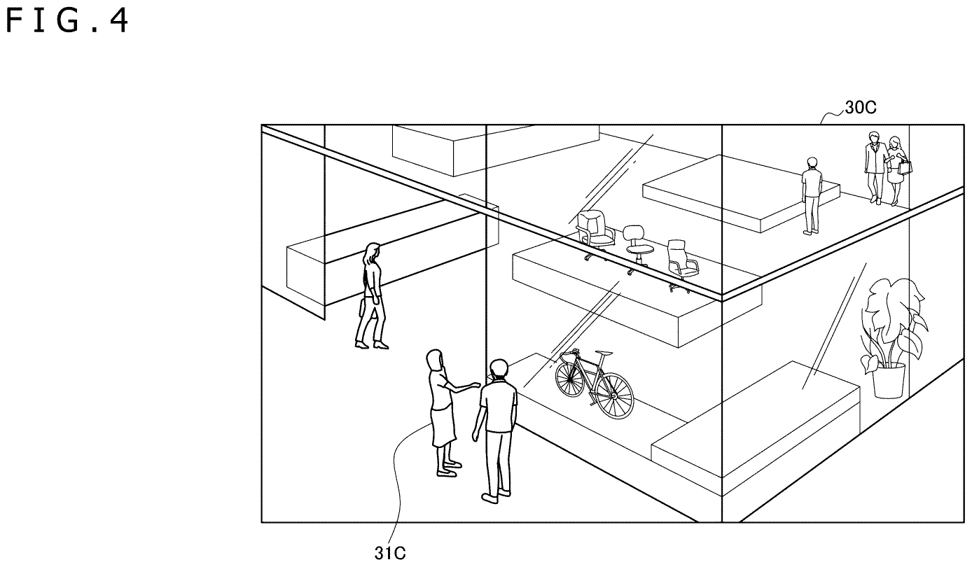

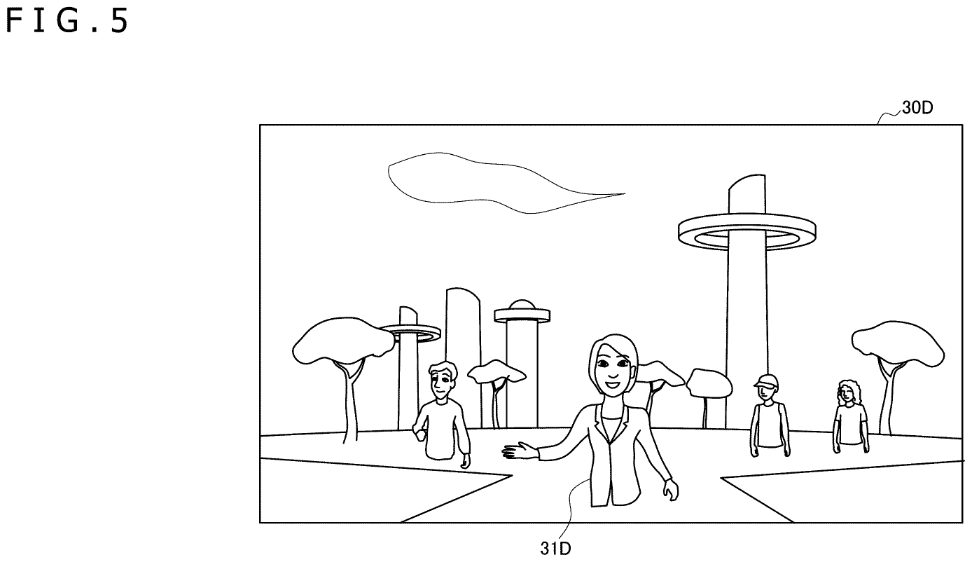

For example, a metaverse 30A illustrated in FIG. 2 is represented as an urban space, and a character 31A in the metaverse 30A is represented as a semi-realistic person who is substantially five-heads tall. A metaverse 30B illustrated in FIG. 3 is represented as a space with rich nature, and a character 31B in the metaverse 30B is represented as a deformed person who is 2.5-heads tall. A metaverse 30C illustrated in FIG. 4 is represented as a sophisticated and simple space, and a character 31C in the metaverse 30C is represented as a semi-realistic person who is substantially seven-heads tall. A metaverse 30D illustrated in FIG. 5 is represented as a futuristic space, and a character 31D in the metaverse 30D is represented as only the upper body of a semi-realistic person who is substantially five-heads tall.

In the metaverses 30A, 30B, 30C, and 30D described above, shapes of the placed characters 31A, 31B, 31C, and 31D and worldviews are significantly different from one another. Hence, it is difficult to deploy the same content (character or the like) to these metaverses 30A, 30B, 30C, and 30D without causing discomfort.

The technique according to the present disclosure has been devised in view of the above circumstances. The technique according to the present disclosure enables adjustment of 3D object data regarding a three-dimensional object (hereinafter referred to also as a 3D object) that a user deploys to a metaverse, on the basis of an analysis result obtained by analysis of visual features of the metaverse. Thus, the technique according to the present disclosure can adjust the appearance of the 3D object to be deployed to the metaverse by the user, in such a manner as to fit the visual features of each metaverse. Accordingly, it is possible for the user to deploy the 3D object corresponding to the same 3D object data to various metaverses in a manner making the 3D object fit the worldview of each metaverse.

### 2. Configuration Example

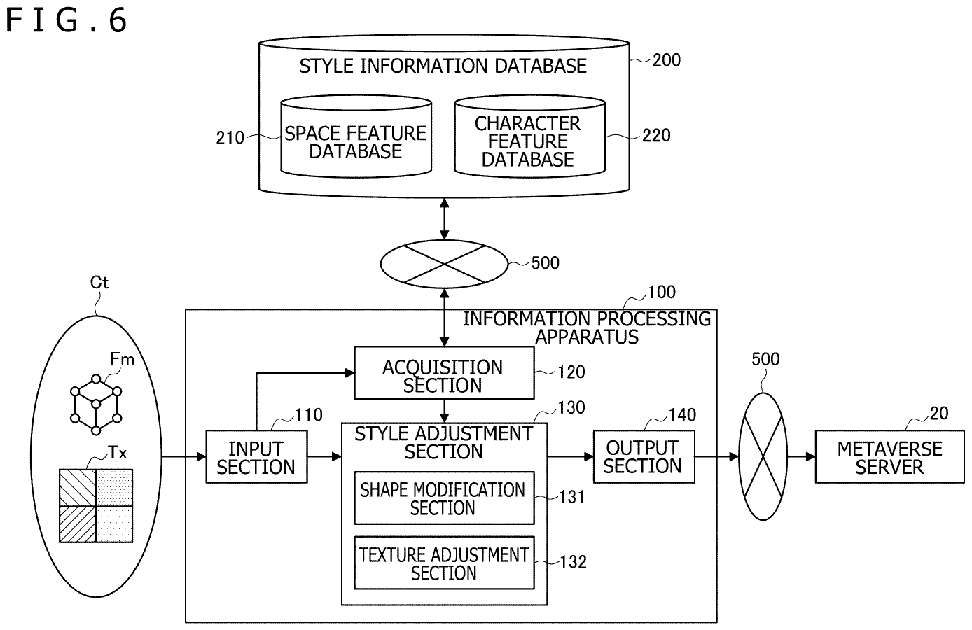

Described next will be an information processing apparatus 100 that implements the technique according to the present disclosure, with reference to FIG. 6. FIG. 6 is a block diagram describing a configuration of the information processing apparatus 100 according to the embodiment of the present disclosure.

As illustrated in FIG. 6, the information processing apparatus 100 includes an input section 110, an acquisition section 120, a style adjustment section 130, and an output section 140.

The input section 110 is an input interface for receiving input of content data Ct to be deployed to a metaverse by a user. The input section 110, for example, may be an input device such as a mouse, a keyboard, a touch panel, a button, a switch, or a lever, may be a connection interface such as a USB (Universal Serial Bus) port to which data can be inputted externally, or may be a communication interface such as a wired or wireless LAN (Local Area Network), Wi-Fi (registered trademark), or Bluetooth (registered trademark).

The content data Ct is 3D object data to be deployed to the metaverse by the user. The content data Ct may be data regarding a user's avatar character, for example. The content data Ct includes data regarding a shape Fm of the 3D object to be deployed to the metaverse and data regarding a texture Tx of the 3D object.

Examples of the texture Tx of the 3D object include data regarding a surface of the 3D object representing the color, texture, or material.

The acquisition section 120 acquires the analysis result obtained by analysis of the visual features of the metaverse, from a style information database 200.

Specifically, the visual features of the metaverse include a feature of an environment of the metaverse and a feature of a character placed in the metaverse. The analysis result of the environment feature of the metaverse is stored in a space feature database 210 in the style information database 200, and the analysis result of the character feature is stored in a character feature database 220 in the style information database 200.

The environment feature of the metaverse includes a feature relating to at least one of color space distribution, the number of colors, a luminance histogram, a spatial resolution, an edge line thickness of an object, or a contrast level in the metaverse, for example. The result of analysis of the above features regarding the environment of the metaverse is stored in the space feature database 210.

Further, the analysis result of the environment feature of the metaverse may be a result of classifying the environment of the metaverse into one of multiple predetermined patterns. Specifically, the analysis result of the environment feature of the metaverse may be a result of classifying the environment of the metaverse into one of predetermined patterns such as realistic, semi-realistic, deformed, metallic, pastel, or polygonal.

The character feature includes a feature relating to at least one of the number of heads tall of a character placed in the metaverse or presence or absence of a body part (e. g., lower body, arms, nose, or ears) of the character, for example. The result of analysis of the above features of the character placed in the metaverse is stored in the character feature database 220. The analysis result of the character feature is acquired, for example, by recognizing a character from a screenshot image of the metaverse, further recognizing the face, body, clothing, and the like of the recognized character, and then analyzing each recognized element.

For analysis of the visual features of the metaverse, a machine learning technique such as pattern recognition or clustering may be used, for example. The analysis of the visual features of the metaverse is performed in advance for each metaverse, and the analysis result is stored in the style information database 200.

Alternatively, the analysis of the visual features of the metaverse may be performed every time the information processing apparatus 100 adjusts the 3D object data.

The style adjustment section 130 adjusts the content data Ct on the basis of the analysis result of the visual features of the metaverse. The style adjustment section 130 includes a shape modification section 131 that adjusts data relating to the shape Fm of the content data Ct and a texture adjustment section 132 that adjusts data relating to the texture Tx of the content data Ct.

As an example, the style adjustment section 130 may adjust the content data Ct in such a manner that the shape Fm and the texture Tx of the content data Ct become similar to the visual features of the metaverse, on the basis of the analysis result of the visual features of the metaverse.

In such a case, for example, the shape modification section 131 may deform a contour of the shape Fm of the content data Ct. Further, in a case where the content data Ct is data regarding an avatar character, the shape modification section 131 may change the number of heads tall of the character, the presence or absence of a body part of the character, or the like on the basis of the analysis result of the character feature described above.

The texture adjustment section 132 may, for example, adjust a color, contrast, a luminance histogram, a sense of noise, or the like of the texture Tx of the content data Ct. The texture adjustment section 132 may adjust the color, the contrast, the luminance histogram, the sense of noise, or the like of the texture Tx of the content data Ct on the basis of the analysis result of the environment feature described above.

As another example, the style adjustment section 130 may generate multiple pieces of variation data by modifying the content data Ct. The style adjustment section 130 can select a piece of variation data that is the most similar to the visual features of the metaverse on the basis of the analysis result of the visual features of the metaverse, and adopt the selected piece of variation data as the adjusted content data Ct.

In such a case, the shape modification section 131 may change the contour of the shape Fm of the content data Ct, the number of heads tall of the character, the presence or absence of a body part of the character, or the like on the basis of a predetermined rule base. The texture adjustment section 132 may change the color, the contrast, the luminance histogram, the sense of noise, or the like of the texture Tx of the content data Ct on the basis of a predetermined rule base. The style adjustment section 130 may select, from multiple pieces of variation data obtained by combining these changes of the shape Fm and the texture Tx of the content data Ct, a piece of variation data that is the most similar to the visual features of the metaverse.

In addition, the style adjustment section 130 may adjust the content data Ct to make it similar to the visual features of the metaverse, by using a style transfer technique using machine learning. Specifically, the style transfer technique is a technique that uses machine learning to output, from two inputs, i.e., a content image that ensures a structure and a style image that ensures an image style, a composite image having both the structure of the former and the image style of the latter.

With such a style transfer technique applied, the style adjustment section 130 can generate adjusted content data Ct having both the structure of the content data Ct and the style of the metaverse from the two inputs, i.e., the content data Ct and the screenshot image of the metaverse.

Moreover, the style adjustment section 130 may generate multiple pieces of adjusted content data Ct by using the style transfer technique. In such a case, the user can select a piece of content data Ct that is more suitable for deployment to the metaverse, from the multiple pieces of adjusted content data Ct generated by the style adjustment section 130.

It is to be noted that, depending on a range of adjustment of the content data Ct by the style adjustment section 130, it can be difficult to ensure identity of the content data Ct. To avoid such a situation, limitations may be imposed by the user on the range of the adjustment of the content data Ct by the style adjustment section 130. For example, the user may impose limitations on a range of adjustment of the color or contrast of the texture Tx of the content data Ct or on a range of change in the number of heads tall of the character.

The output section 140 transmits the adjusted content data Ct to the metaverse server 20 so that a 3D object corresponding to the content data Ct is placed in the metaverse. With the adjusted content data Ct transmitted to the metaverse server 20 by the output section 140, the 3D object corresponding to the content data Ct is deployed to the metaverse. The output section 140 may be a communication card for a wired or wireless LAN (Local Area Network), Wi-Fi (registered trademark), Bluetooth (registered trademark), or WUSB (Wireless USB) or may be a router for optical communication, a router for ADSL (Asymmetric Digital Subscriber Line), a modem for various kinds of communication, or the like.

It is to be noted that the output section 140 may present the 3D object corresponding to the adjusted content data Ct to the user before the adjusted content data Ct is transmitted to the metaverse server 20. This allows the user to check the 3D object to be actually deployed to the metaverse, so that the user can make a final determination as to whether or not the adjustment of the content data Ct by the style adjustment section 130 is acceptable.

With the configuration described above, the information processing apparatus 100 can adjust the appearance of the 3D object prepared by the user, in such a manner as to fit the visual features of the metaverse.

Accordingly, the information processing apparatus 100 can make the appearance of the 3D object to be deployed to the metaverse fit the worldview of the metaverse better.

Furthermore, the information processing apparatus 100 can deploy the 3D object prepared by the user to multiple metaverses while making the appearance of the 3D object fit the respective worldviews of the metaverses.

Hence, the information processing apparatus 100 can support the user to participate in multiple metaverses.

### 3. Operation Examples

### 3.1. First Operation Example

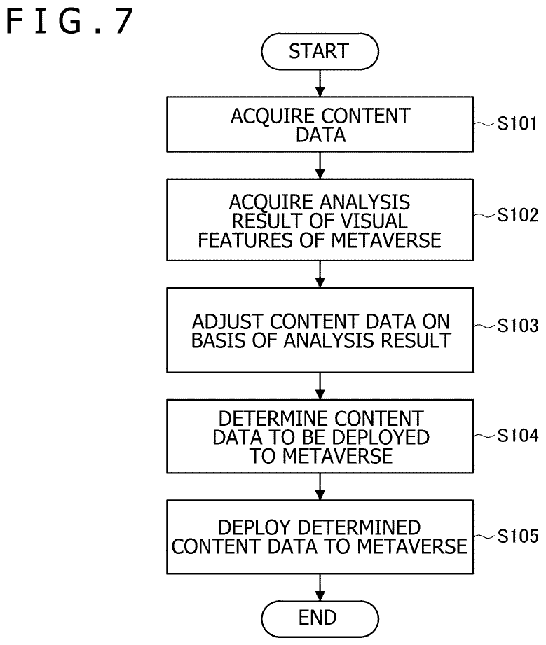

Described next will be a first operation example of the information processing apparatus 100 according to the present embodiment with reference to FIG. 7. FIG. 7 is a flowchart illustrating a flow of the first operation example of the information processing apparatus 100 according to the present embodiment.

As illustrated in FIG. 7, first, the information processing apparatus 100 acquires the content data Ct regarding the 3D object to be deployed to the metaverse (S101). The content data Ct may be data regarding the user's avatar character or may be data regarding the 3D object created by the user.

Then, the information processing apparatus 100 acquires the analysis result of the visual features of the metaverse to which the 3D object corresponding to the content data Ct is to be deployed, from the style information database 200 (S102). Subsequently, the information processing apparatus 100 adjusts each of the shape Fm and the texture Tx, which are elements of the content data Ct, on the basis of the acquired analysis result of the visual features (S103).

Next, the information processing apparatus 100 presents the 3D object corresponding to the adjusted content data Ct to the user. When the user checks and approves the 3D object corresponding to the adjusted content data Ct, the adjusted content data Ct to be deployed to the metaverse is determined (S104).

Thereafter, the information processing apparatus 100 transmits the determined content data Ct to the metaverse server 20 (S105). Accordingly, the information processing apparatus 100 can deploy the 3D object corresponding to the content data Ct to the metaverse in a state fitting the visual features of the metaverse.

According to the first operation example, the information processing apparatus 100 can adjust the shape Fm and the texture Tx of the content data Ct in such a manner as to make them similar to the visual features of the metaverse. Therefore, the information processing apparatus 100 can adjust the content data Ct in such a manner as to make it fit the worldview of the metaverse more suitably.

### 3.2. Second Operation Example

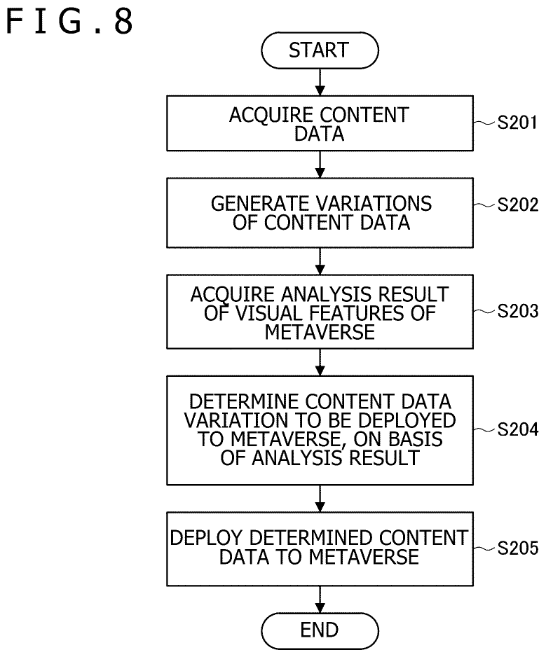

Further, a second operation example of the information processing apparatus 100 according to the present embodiment will be described with reference to FIG. 8. FIG. 8 is a flowchart illustrating a flow of the second operation example of the information processing apparatus 100 according to the present embodiment.

As illustrated in FIG. 8, first, the information processing apparatus 100 acquires the content data Ct regarding the 3D object to be deployed to the metaverse (S201). The content data Ct may be data regarding the user's avatar character or may be data regarding the 3D object created by the user.

Then, the information processing apparatus 100 modifies the shape Fm and the texture Tx of the content data Ct on the basis of a predetermined rule base, to generate multiple pieces of variation data regarding the content data Ct (S202). Subsequently, the information processing apparatus 100 acquires the analysis result of the visual features of the metaverse to which the 3D object corresponding to the content data Ct is to be deployed, from the style information database 200 (S203).

The information processing apparatus 100 then selects, from the generated pieces of variation data regarding the content data Ct, a piece of variation data that fits the visual features of the metaverse, on the basis of the acquired analysis result of the visual features. The information processing apparatus 100 thus determines the selected piece of variation data as the adjusted content data Ct to be deployed to the metaverse (S204).

Thereafter, the information processing apparatus 100 transmits the determined content data Ct to the metaverse server 20 (S205). Accordingly, the information processing apparatus 100 can deploy the 3D object corresponding to the content data Ct to the metaverse in a state fitting the visual features of the metaverse.

According to the second operation example, the information processing apparatus 100 can generate multiple pieces of variation data by modifying the shape Fm and the texture Tx of the content data Ct on the basis of the predetermined rule base. Therefore, the information processing apparatus 100 can impose finer limitations on the range of adjustment of the content data Ct.

### 4. Hardware Configuration Example

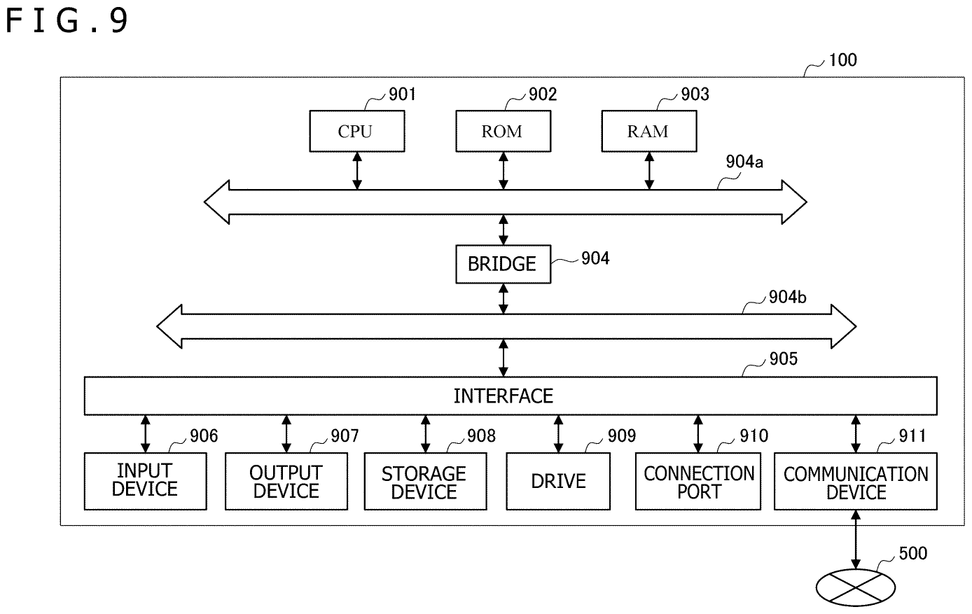

A hardware configuration of the information processing apparatus 100 according to the present embodiment will be described with reference to FIG. 9. FIG. 9 is a block diagram illustrating a hardware configuration example of the information processing apparatus 100 according to the present embodiment.

Functions of the information processing apparatus 100 according to the present embodiment can be implemented by cooperation between software and hardware described below. Functions of the style adjustment section 130 may be executed, for example, by a CPU 901.

Functions of the input section 110 may be executed, for example, by an input device 906, a connection port 910, or a communication device 911. Functions of the acquisition section 120 and the output section 140 may be executed, for example, by the communication device 911.

As illustrated in FIG. 9, the information processing apparatus 100 includes the CPU (Central Processing Unit) 901, a ROM (Read Only Memory) 902, and a RAM (Random Access Memory) 903.

The information processing apparatus 100 may further include a host bus 904a, a bridge 904, an external bus 904b, an interface 905, the input device 906, an output device 907, a storage device 908, a drive 909, the connection port 910, or the communication device 911. The information processing apparatus 100 may have, in place of or in addition to the CPU 901, a processing circuit such as a DSP (Digital Signal Processor) or an ASIC (Application Specific Integrated Circuit).

The CPU 901 functions as an arithmetic processing unit or a control unit and controls operation in the information processing apparatus 100 in accordance with various programs recorded in the ROM 902, the RAM 903, the storage device 908, or a removable recording medium mounted to the drive 909. The ROM 902 stores therein programs used by the CPU 901, operation parameters, and the like. The RAM 903 temporarily stores therein programs for use in execution of the CPU 901, parameters used at the time of the execution, and the like.

The CPU 901, the ROM 902, and the RAM 903 are connected to one another by the host bus 904a that enables data transmission at high speed. The host bus 904a is connected to the external bus 904b such as a PCI (Peripheral Component Interconnect/Interface) bus via the bridge 904, and the external bus 904b is connected to the various constituent elements via the interface 905.

The input device 906 is, for example, a device that accepts input made by the user, such as a mouse, a keyboard, a touch panel, a button, a switch, or a lever.

It is to be noted that the input device 906 may be a microphone or the like that detects voice of the user.

The input device 906 may be, for example, a remote control device using infrared rays or other radio waves, or may be an externally connected device that supports operation of the information processing apparatus 100.

The input device 906 further includes an input control circuit that outputs, to the CPU 901, an input signal generated on the basis of information inputted by the user. The user can operate the input device 906 to input various kinds of data to the information processing apparatus 100 or make instructions for processing operation of the information processing apparatus 100.

The output device 907 is a device capable of visually or aurally presenting information acquired or generated in the information processing apparatus 100 to the user. The output device 907, for example, may be a display device such as a LCD (Liquid Crystal Display), a PDP (Plasma Display Panel), an OLED (Organic Light Emitting Diode) display, a hologram, or a projector, may be a sound output device such as a speaker or headphones, or may be a printing device such as a printer. The output device 907 can output information obtained by the processing by the information processing apparatus 100, as video such as text or images and as sound such as voice or audio.

The storage device 908 is a data storage device configured as an example of a storage section of the information processing apparatus 100. The storage device 908 may be, for example, formed by a magnetic storage device such as an HDD (Hard Disk Drive), a semiconductor storage device, an optical storage device, a magneto-optical storage device, or the like. The storage device 908 can store therein programs executed by the CPU 901, various kinds of data, various kinds of data acquired externally, and the like.

The drive 909 is a device that reads or writes data from or into a removable recording medium such as a magnetic disk, an optical disk, a magneto-optical disk, or a semiconductor memory, and is incorporated in or externally attached to the information processing apparatus 100. For example, the drive 909 can read information recorded in the mounted removable recording medium and output the read information to the RAM 903.

Further, the drive 909 can write records into the mounted removable recording medium.

The connection port 910 is a port for direct connection between an externally connected device and the information processing apparatus 100. For example, the connection port 910 may be a USB (Universal Serial Bus) port, an IEEE1394 port, a SCSI (Small Computer System Interface) port, or the like. Alternatively, the connection port 910 may be an RS-232C port, an optical audio terminal, an HDMI (registered trademark) (High-Definition Multimedia Interface) port, or the like. The connection port 910 connected with the externally connected device enables transmission and reception of various kinds of data between the information processing apparatus 100 and the externally connected device.

The communication device 911 is a communication interface formed by a communication device or the like for connection to the network 500, for example. The communication device 911 may be, for example, a communication card or the like for a wired or wireless LAN (Local Area Network), Wi-Fi (registered trademark), Bluetooth (registered trademark), or WUSB (Wireless USB). Further, the communication device 911 may be a router for optical communication, a router for ADSL (Asymmetric Digital Subscriber Line), a modem for various kinds of communication, or the like.

The communication device 911 can transmit and receive signals and the like, for example, to and from the Internet or other communication devices by using a predetermined protocol such as TCP/IP. Further, the network 500 connected to the communication device 911 is a network connected in a wired or wireless manner and, for example, may be an Internet communication network, a home LAN, an infrared communication network, a radio wave communication network, a satellite communication network, or the like.

It is to be noted that it is also possible to generate a program for causing hardware such as the CPU 901, the ROM 902, and the RAM 903 incorporated in a computer to perform functions equivalent to those of the information processing apparatus 100 described above. It is also possible to provide a computer-readable recording medium having the program recorded therein.

While the preferred embodiment of the present disclosure has been described in detail above with reference to the attached drawings, the technical scope of the present disclosure is not limited to such an embodiment. It is obvious that any person ordinarily skilled in the art to which the present disclosure pertains can conceive of various alterations and modifications within the scope of the technical ideas described in the claims. Such alterations and modifications are also naturally construed as belonging to the technical scope of the present disclosure.

Furthermore, the effects described in the present specification are merely descriptive or exemplary and not limitative. That is, the technique according to the present disclosure can produce, in addition to or in place of the above effects, other effects that are apparent to a person skilled in the art from the description of the present specification.

Note that such following configurations also belong to the technical scope of the present disclosure.

(1)

An information processing apparatus including:
an acquisition section that acquires an analysis result of visual features of a virtual world;
a style adjustment section that adjusts a user's 3D object data on the basis of the analysis result; and
an output section that deploys the adjusted 3D object data to the virtual world so as to place a 3D object corresponding to the 3D object data in the virtual world.
   (2)

The information processing apparatus according to (1) above, in which the visual features include a feature of an environment of the virtual world and a feature of a character placed in the virtual world.

(3)

The information processing apparatus according to (2) above, in which the feature of the environment includes a feature relating to at least any one of color space distribution, a luminance histogram, an edge line thickness, a contrast level, or a resolution of the environment.

(4)

The information processing apparatus according to (3) above, in which the analysis result of the feature of the environment includes a result of classifying the environment into one of multiple predetermined patterns.

(5)

The information processing apparatus according to any one of (2) to (4) above, in which the feature of the character includes a feature relating to at least any one of the number of heads tall or presence or absence of a body part of the character.

(6)

The information processing apparatus according to any one of (1) to (5) above, in which the style adjustment section adjusts the 3D object data in such a manner that a shape and a surface texture of the 3D object become similar to the visual features.

(7)

The information processing apparatus according to any one of (1) to (5) above, in which the style adjustment section generates multiple pieces of variation data corresponding to respective variation objects obtained by modifying the 3D object, and selects, as the adjusted 3D object data, a piece of the variation data in which a shape and a surface texture of the variation object are most similar to the visual features.

(8)

The information processing apparatus according to any one of (1) to (7) above, in which a range of adjustment of the 3D object data by the style adjustment section is limited on the basis of an instruction from the user.

(9)

The information processing apparatus according to any one of (1) to (8) above, in which the output section presents the 3D object corresponding to the adjusted 3D object data to the user before the adjusted 3D object data is deployed to the virtual world.

(10)

The information processing apparatus according to any one of (1) to (9) above, in which the 3D object includes an avatar character of the user.

An information processing method executed by a computer, including:
acquiring an analysis result of visual features of a virtual world;
adjusting a user's 3D object data on the basis of the analysis result; and
deploying the adjusted 3D object data to the virtual world so as to place a 3D object corresponding to the 3D object data in the virtual world.
   (12)

A program for causing a computer to function as:
an acquisition section that acquires an analysis result of visual features of a virtual world;
a style adjustment section that adjusts a user's 3D object data on the basis of the analysis result; and
an output section that deploys the adjusted 3D object data to the virtual world so as to place a 3D object corresponding to the 3D object data in the virtual world.

### REFERENCE SIGNS LIST

10: User terminal
20: Metaverse server
100: Information processing apparatus
110: Input section
120: Acquisition section
130: Style adjustment section
131: Shape modification section
132: Texture adjustment section
140: Output section
200: Style information database
210: Space feature database
220: Character feature database
500: Network
Ct: Content data
Fm: Shape
Tx: Texture

1. An information processing apparatus comprising:
an acquisition section that acquires an analysis result of visual features of a virtual world;
a style adjustment section that adjusts a user's 3D object data on a basis of the analysis result; and
an output section that deploys the adjusted 3D object data to the virtual world so as to place a 3D object corresponding to the 3D object data in the virtual world.

2. The information processing apparatus according to claim 1, wherein the visual features include a feature of an environment of the virtual world and a feature of a character placed in the virtual world.

3. The information processing apparatus according to claim 2, wherein the feature of the environment includes a feature relating to at least any one of color space distribution, a luminance histogram, an edge line thickness, a contrast level, or a resolution of the environment.

4. The information processing apparatus according to claim 3, wherein the analysis result of the feature of the environment includes a result of classifying the environment into one of multiple predetermined patterns.

5. The information processing apparatus according to claim 2, wherein the feature of the character includes a feature relating to at least any one of the number of heads tall or presence or absence of a body part of the character.

6. The information processing apparatus according to claim 1, wherein the style adjustment section adjusts the 3D object data in such a manner that a shape and a surface texture of the 3D object become similar to the visual features.

7. The information processing apparatus according to claim 1, wherein the style adjustment section generates multiple pieces of variation data corresponding to respective variation objects obtained by modifying the 3D object, and selects, as the adjusted 3D object data, a piece of the variation data in which a shape and a surface texture of the variation object are most similar to the visual features.

8. The information processing apparatus according to claim 1, wherein a range of adjustment of the 3D object data by the style adjustment section is limited on a basis of an instruction from the user.

9. The information processing apparatus according to claim 1, wherein the output section presents the 3D object corresponding to the adjusted 3D object data to the user before the adjusted 3D object data is deployed to the virtual world.

10. The information processing apparatus according to claim 1, wherein the 3D object includes an avatar character of the user.

11. An information processing method executed by a computer, comprising:
acquiring an analysis result of visual features of a virtual world;
adjusting a user's 3D object data on a basis of the analysis result; and
deploying the adjusted 3D object data to the virtual world so as to place a 3D object corresponding to the 3D object data in the virtual world.

12. A program for causing a computer to function as:
an acquisition section that acquires an analysis result of visual features of a virtual world;
a style adjustment section that adjusts a user's 3D object data on a basis of the analysis result; and
an output section that deploys the adjusted 3D object data to the virtual world so as to place a 3D object corresponding to the 3D object data in the virtual world.
